(19) United States
(12) Patent Application Publication
(10) Pub. No.: US 2010/0241513 A1
(43) Pub. Date: Sep. 23, 2010

(54) SYSTEM AND METHOD FOR FRANCHISE PROMOTION

(75) Inventors: Rajneel Prasad, Fremont, CA (US); Jason Hilton, San Francisco, CA (US)

Correspondence Address: IPxLAW Group LLP, 95 South Market Street, Suite 570, San Jose, CA, 95113, US

(73) Assignee: WDFA MARKETING, INC., San Francisco, CA (US)

(21) Appl. No.: 12/709,452

(22) Filed: Feb. 19, 2010

Related U.S. Application Data
(60) Provisional application No. 61/154,394, filed on Feb. 21, 2009.

(51) Int. Cl. G06Q 30/00; G06Q 10/00; G06Q 99/00

(52) U.S. Cl. 705/14.52; 705/14.69; 705/14.72; 705/310

(57) ABSTRACT

A method and system for franchisees to author, produce, and/or distribute preapproved marketing materials are disclosed. In some aspects, a franchisor can install various data relating to a franchise into a system. The data can comprise content and rules for preapproved promotion. The data can also include information relating to franchisees such franchisee locations, marketing and/or demographic information relating to customers, and/or other characteristic information. With the system, a franchisee can select a form and/or media for a preapproved promotion that can be limited using predetermined rules. In various embodiments, a franchisor can input specifications for preapproved promotion products and can authorize preselected franchisees to author a preapproved promotion and/or distribute media in the promotion to preapproved market recipients. The scope of content and/or distribution can depend on the franchisee, on a geographic and/or demographic limitation, and/or on various other parameters. Various embodiments offer a preapproved cooperative promotion to franchisees.

### CROSS REFERENCE TO RELATED APPLICATIONS

This application claims priority 35 U.S.C. §119(e) to U.S. Provisional Patent Application Ser. No. 61/154,394 filed on Feb. 22, 2009, the entire contents of which are hereby incorporated by reference.

### FIELD

The present disclosure relates generally to licensed businesses, and more particularly relates to providing methods for authoring, ordering and/or obtaining preauthorized marketing materials for distribution to prospective customers of a franchisee.

### BACKGROUND

Distributing marketing materials to prospective customers is an important means to increase sales of a business. A number of businesses are based on license agreements, wherein a sellers' marketing and/or promotion materials must be approved by a licensor before the materials are transmitted to customers. In particular, various licensing terms can require that promotion materials sent by a licensed franchisee be approved in advance by a franchisor pursuant to the terms of a franchise agreement.

Franchise marketing materials such as brochures, flyers, posters, media presentations, and others, can comprise logos, text, photographs, and other visual and/or other sensory information. By the terms of the franchise, a franchisor may require that this content have certain relative proportions, positions, characteristic fonts, colors and/or other aspects characteristic of a brand, and/or be subject to a franchisor's final approval. Requirements from a franchisor may also depend on the geographical location(s) of a franchisee's stores and/or markets, demographics of the customers targeted for a promotion (ethnicity, age, gender, etc.), and temporal variables such as a day of a week, a season, and others.

In general, it can be difficult for a franchisee to find a suitable producer and/or publisher (for example a publisher to compose and print promotion flyers) that meet a franchisors requirements for approval (exemplary requirements can include colorimetric specifications for photos, logos and/or type, specialized typefaces, sounds and sound sequencing in multimedia presentations, and others) and/or acceptable cost. Furthermore, while it is possible for various franchisees to save costs and/or reach broader markets through cooperative production and distribution of marketing materials, the expense and logistics in finding suitable partners, producing and/or publishing cooperative materials, and/or obtaining a franchisor's approval for the cooperative production and materials, can be burdensome and costly.

Individualized review and approval of marketing material and/or cooperative promotions can also be laborious and/or costly for a franchisor. Approval of content can depend on regional and/or demographic criteria, and/or various terms of individualized agreements with franchisees. Hence administering the approval process often requires that a franchisor laboriously review many aspects of a proposed promotion and the associated media.

There has long been long felt need for methods and systems to reduce costs for a franchisee to author, produce, obtain approval for, and/or distribute marketing materials in a promotion. As well, there has been long felt need for methods and systems useful for a franchisee to select a market based on demographic, geographic and/or other variables, to economically produce a promotion in media for the selected market, to obtain franchisor approval for the promotion, and to selectively deliver the promotion to the selected market. Furthermore there is need for systems and methods for a franchisor to provide timely approval to a franchisee, for a plurality of franchisees to pool resources, and/or to selectively distribute franchisor and/or franchisee promotions to preselected markets at lower cost.

### SUMMARY

A method, system, and article of manufacture for producing preapproved marketing materials for a promotion are disclosed. In an embodiment, the system has a module for an authorized administrator to enter information into machine readable media, a module operable for a franchisee to author a preapproved promotion, and a module for the franchisee to order a media master of the preapproved promotion. The module can have data and instructions operable for the franchisee to perform the authoring, send the preapproved promotion to an approved producer of a media master, and make electronic payment for the media master. There is also an embodiment having means for the franchisee to publish the preapproved promotion to selected recipients.

One aspect of the invention is a method for providing licensor preapproval for a promotion of a licensed product and/or service using a computer system. The method comprises receiving filtering rules, and at least one promotion media layout template for media in a promotion from the licensor. The method also includes receiving mandatory and/or alternative content for media in a promotion, and at least one promotion product specification from the licensor. The promotion product specification identifies promotion media for a preapproved promotion product, and the filtering rules and media layout template are operable to limit a layout, content, and/or attribute in the promotion media of the preapproved promotion product. In addition, the method includes storing the promotion product specification, filtering rules, media layout template, and/or alternative content in tangible system media and receiving information from a licensee in a licensee user interface of the system. The licensee information comprises an identifying characteristic of the licensee, a promotion product selection for a promotion, a content selection, an attribute selection, and a store and/or market selection.

The method also includes selecting a set of filtering rules from among the stored filtering rules in the system. The set of filtering rules is operable to filter at least a portion of the information from the licensee. The selection is performed without human intervention by the system and the set of filtering rules is selected based on at least one parameter selected from among the group consisting of an identifying characteristic of the licensee, the promotion product selection, the content selection, and the store and/or market selection.

Still further, the method includes filtering at least the portion of licensee information using the selected filtering rule set without human intervention, preapproving the promotion based on the filtering without human intervention, and storing a representation of the preapproved promotion in the tangible system media. A machine readable representation of the preapproved promotion media is sent to a preapproved producer of a media master.

Another aspect of the invention is a preapproved promotion is provided using the method. There are embodiments of the preapproved promotion provided using a system having data and instructions to implement the method in tangible system media, where the system has at least one processor that can perform the method using those instructions and data. There are also preapproved promotion embodiments provided using method steps further including accepting an order, accepting electronic payment from the licensee for the preapproved promotion product, and reporting a current status of the order to the licensee. The accepting and the reporting are effectuated in a user interface of the system without any licensor interaction. Further preapproved promotion embodiments are also provided using the method wherein the method is performed using a database having demographic and/or geographic information related to the one or more stores, and the market selection comprises finding recipients for the promotion product based on the demographic and/or geographic information in the database.

Another aspect of the invention is a system comprising data and instructions operable to perform the method in tangible media of the system and at least one processor that can perform the instructions and operate on the date to perform the method.

Yet another aspect of the invention is an article of manufacture comprising machine readable data and instructions in tangible media. The data and instructions are operable for a processor to perform the method.

There are embodiments of the method further comprising accepting an order and an electronic payment for the preapproved promotion product from the licensee, reporting a current status of the order to a licensee, and publishing the promotion. The accepting, reporting, and publishing are performed without licensor interaction.

Yet other embodiments of the method comprise receiving alternative trade dress and/or trademark content from the licensor and storing it in tangible system media. In these embodiments, information comprising content, an instruction to place the licensee content in a first position of the authoring template, a selection from among the licensor trade dress and/or trademark content, and an instruction to place the trade dress and/or trademark content in a second position of the authoring template are received from the licensee. In these embodiments, the preapproval depends on the trade dress and/or trademark selection in the second position and/or the licensee content in the first position of the authoring template.

In further embodiments, the method is performed with a system comprising a demographic and/or geographic database having recipient information relating to the licensed product and/or service. The market selection comprises designating recipients for the promotion product based on querying the database. There also are various embodiments where a system database has demographic and/or geographic characteristics associated with store selection and/or market selection and a least some affinity content relating to those characteristics. In a number of these embodiments the method provides for at least some of the affinity content to be included in the promotion media. Furthermore, in a number of these various embodiments, the system is operable to produce a map showing the selected store location and a geographical area relating to the market selection, and the method includes providing such map content in the promotion media.

Still another aspect of the invention is a system for a licensee to effectuate a preapproved promotion of a licensed product and/or service with no licensor intervention. The system comprises machine readable media operable to store information comprising data and instructions and a processor operable to perform the instructions and operate on the data. The stored instructions and data are operable to implement a module operable for a licensee to select a promotion product for a promotion, a module operable for the licensee to author promotion media for the promotion product with no licensor interaction, a module operable for the licensee to order the promotion product for the promotion, a module operable for the licensee to make an electronic payment for the order, a module operable for a licensee to track the status of the order for the promotion, and a module operable to send a representation of preapproved authored promotion media to a preapproved producer of a media master.

There are embodiments of the system further comprising a system database including promotion products, alternative media layout forms operable to author least one product promotion, alternative content including alternative trade dress, and/or alternative media operable for the licensee to select for a preapproved product. The authoring module comprises a design laboratory module operable for the licensee to select at least a form, content, trade dress, and/or media options in a user interface to the system.

A number of the system embodiments further comprise an administrative user interface operable for an administrator to install content and rules in the machine readable media. The content and rules are operable for the licensee to perform the authoring and the ordering of the preapproved promotion media. These embodiments include an administrative user interface operable for an administrator to allow and/or disallow the licensee to access the system, to author a predetermined product; and/or to order a predetermined product. Also, these embodiments include an administrative interface operable for an administrator to define a scope of a preapproved promotion product, wherein the scope of what is preapproved depends on the licensee.

In addition, there are embodiments of the system further comprising a module operable for a licensee to select a market based on demographic and/or geographic variables, and a module to distribute the preapproved promotion in the market.

There is a system aspect for a licensee to author and publish a preapproved promotion product with no licensor intervention. In this aspect, the system comprises means for the licensee to select the promotion product, to select content for the promotion product, to produce a media master for the promotion product, to select recipients for the promotion product, and to effectuate publication of the promotion product. The aspect also has means for a licensor to limit form, content, media, and/or recipients of the promotion product without human intervention, and means for the licensee to pay for the preauthorized promotion product without licensor interaction. There are various embodiments of this aspect further comprising means for the licensee to participate in a cooperative promotion.

### BRIEF DESCRIPTION OF DRAWINGS

Various embodiments are illustrated in an exemplary manner by the accompanying drawings. The drawings and accompanying description should be understood to explain principles of the embodiments rather than be limiting. Other embodiments will become apparent from the description and the following drawings:

FIG. 1 is a diagram showing portions of an embodiment for creating preapproved media for publication.

FIG. 2 is a simplified diagram of a system for authoring a preapproved promotion.

FIG. 3A is a simplified diagram showing aspects of an embodiment for authoring a preapproved promotion.

FIG. 3B is a simplified diagram showing aspects of an embodiment for authoring a preapproved and/or a later approved promotion.

FIG. 4 shows aspects of a system having various administrators and/or franchisees.

### DETAILED DESCRIPTION

Systems and methods for franchisees to author, produce, and/or distribute preapproved marketing materials are disclosed. In some embodiments, an administrator can install various data relating to a franchise into a system. The data can comprise content and rules for creating a preauthorized promotion. The data can also include information relating to franchisees such as authorized franchisee locations, marketing and/or demographic information related to customers served by a franchise and/or franchisee, and/or other characteristic information. With the system, a franchisee can select a form and/or media for a preapproved promotion. The form and/or content can be selected from a system database and/or can be limited using predetermined rules. In various embodiments, a franchisor can input information into the system. The franchisor information can include a specification defining a preapproved promotion product and can authorize a franchisee and/or predetermined selected franchisee sales location(s) to author promotion media in the product and/or to send the media to preapproved market recipients. The scope of content and/or distribution of a preauthorized promotion product can depend on the franchisee, on a geographic and/or demographic limitation for the promotion, on franchisee location(s) that are being promoted, and/or on various other variables. Furthermore, the various embodiments are useful for a franchisor to offer a preapproved cooperative promotion product to a number of franchisees.

The terminology used herein is for the purpose of describing particular embodiments and is not intended to limit the scope of the claims. It will be understood that, although the terms first, second, etc. may be used to describe various elements, these terms are only used to distinguish one element from another and the elements should not be limited by these terms. For example, a first element could be termed a second element, and similarly a second element could be termed a first element, without departing from the scope of the instant description.

As used herein, the singular forms “a”, “an” and “the” are intended to include the plural forms as well, unless the context clearly indicates otherwise. It will be further understood that the terms “comprises,” “comprising,” “includes,” “including,” “have” and/or “having,” as used herein, are open-ended terms of art that signify the presence of stated features, integers, steps, operations, elements, and/or components, but do not preclude the presence or addition of one or more other features, integers, steps, operations, elements, components, and/or groups thereof. Reference in the specification to “one embodiment”, “an embodiment”, or some embodiment, etc. means that a particular feature, structure, or characteristic described in connection with the embodiment is included in at least one embodiment. The appearances of the phrase “in one embodiment” in various places in the specification are not necessarily all referring to the same embodiment, nor are separate or alternative embodiments mutually exclusive of other embodiments. The phrase “scope of the claims” as used herein references the scope of all claims collectively, rather than the scope of any individual claim.

To clarify certain concepts used in this application, it will be convenient to introduce some definitions. The term communications channel refers to a path, link, or connection through which information passes. A communications channel can comprise a physical link such as a cable connecting two physical units, electromagnetic signals propagating through space, waveguides, transmission lines, and/or the like, or a protocol layer in a computer networking hierarchy, separately or in any combination. The term module can reference a self-contained physical unit or piece of equipment, or a logical component effectuated using a processor and tangible media having instructions and/or data operable for the processor to perform identified function(s).

To simplify explanation, numerous references in the specification are often made to a franchisor and/or franchisee. As used herein, the terms franchisor/franchisee and licensor/licensee are substantially synonymous and explanations in terms of franchisor and/or franchisee will be understood to apply to the parties having a relationship termed licensor and/or licensee, unless explicitly stated otherwise. A licensor, franchisor, licensee, and/or franchisee can be an individual, individuals, and/or a business entity. The terms licensor and franchisor can reference a person and/or an entity owning a bundle of rights, including rights to license for a business. Such rights can include a trademark, a trade name, a design patent, and/or other intellectual property, and a licensor, franchisor, licensee, and/or franchisee can manufacture and/or provide a product, and/or provide a service. Where a franchisor/licensor enters into a contractual relationship to license others (franchisees/licensees) to use at least some of its rights to do business (e.g. to operate under the franchisor's trademark, trade dress, and/or trade name, etc.), there is a license/franchise. Accordingly, the terms franchisor and/or licensor include a corporate sponsor of goods and/or services that are sold and/or distributed subject to various terms of an agreement.

An agreement can limit a licensee/franchisee's rights to sell various products, and/or the manner, media, and/or content of a licensee/franchisee's promotion. For example, a license and/or franchise agreement can limit a licensee/franchisee to sell and/or distribute goods and/or services solely in a certain geographic area. In another aspect, such an agreement can require that a licensee/franchisee include and/or exclude various terms, phrases, trademarks, trade dress, and/or presentation media in a promotion. There can also be various other terms and/or conditions.

A licensor and/or franchisor can receive various forms of consideration from a respective licensee/franchisee. For example, a franchisor can receive an initial franchise fee, and/or can receive various ongoing royalty, product, and/or other fees for doing business under the terms of the franchise. In various embodiments, a licensor/franchisor can retain rights to limit the scope, form, and/or content of a promotion, and can limit its licensees/franchisees to purchase certain goods and/or services from predetermined entities, depending on the terms and/or conditions of an agreement.

In the written description and claims, references to licensor, franchisor, franchisee, corporate sponsor, distributor, retail establishment, licensee, franchisee, and the like will generally be understood to reference the respective persons and/or entities and/or their authorized agents, managers, employees, servants, and/or delegates who perform actions within the scope of their authority, unless the context clearly indicates otherwise. Hence a reference to approval by a franchisor will be understood to include approval by any authorized administrator and/or other delegate of the franchisor, except where levels of authority differing in kind and/or level are distinguished in the specification.

In the following description, for purposes of explanation, numerous specific details are set forth in order to provide a thorough understanding of the various principles. It will be apparent, however, to one skilled in the art, that the principles can be practiced without these specific details. In other instances, structures and devices are shown in simplified form in order to avoid obscuring the concepts.

Various embodiments can provide means for a franchisee to author a preapproved promotion, for a franchisee to order preapproved promotion materials, and/or for a franchisee to effectuate distribution of preapproved promotion materials to various recipients. In the various embodiments a franchisor can install information in a system, comprising data, specifications, and/or rules operable to effectuate preapproved authoring, preapproved production, and/or preapproved distribution of a promotion product. A number of embodiments can determine size, composition, proximity, and/or other characteristics of a selected market based on geographic and/or demographic parameters. Some embodiments can be used for authoring promotion media that are customized for a selected market, and/or can effectuate publishing and/or distributing promotion media to prospective customers and/or entities and/or individuals who can influence customers in the selected markets. Furthermore, the installed information can specifically define one or more preapproved promotion products comprising predefined portions of the authoring data, instructions, and/or rules.

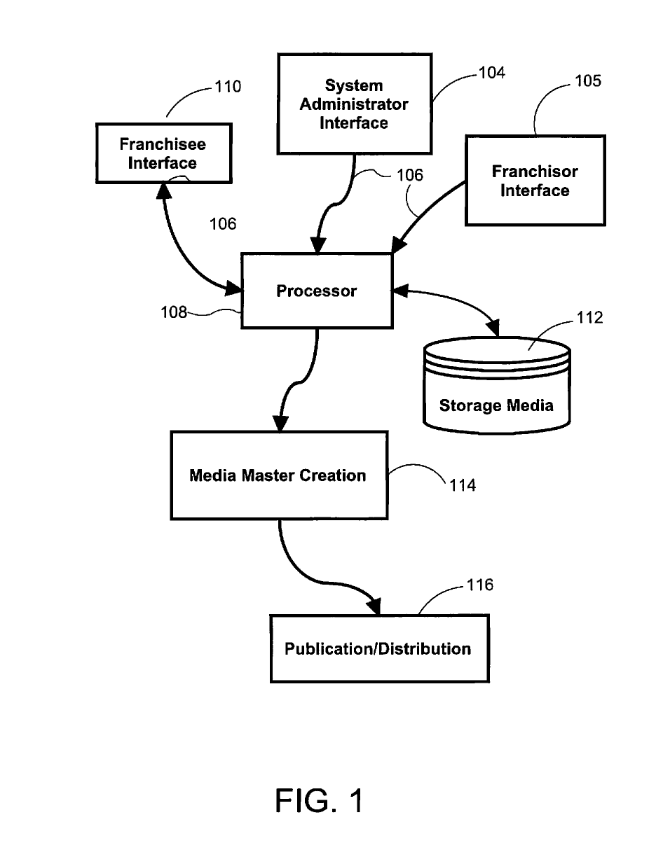

In a system with respect to FIG. 1, an authorized system administrator and/or franchisor can install information a system through a communications channel 106 by way of system administrative 104 and/or franchisor user interfaces 105. The communications channel can be a secure channel such as a virtual private network, a secure dedicated line, and/or others. The information input from a system administrator and/or a franchisor can comprise content and rules for authoring a preapproved promotion. Information sent in a communication channel 106 can be received using a processor 108 operable to store at least a portion of the information in machine readable media 112. The information in the media 112 can comprise instructions and/or data operable for a franchisee to author a preauthorized promotion. The data can include content such as text, artwork, audio, video, and/or other sensory elements useful for authoring preapproved promotions. The media can also have forms, rules and/or instructions for authoring various preapproved promotion products. Furthermore, the installed information can define preapproved promotion products comprising various portions of the authoring instructions and/or data.

Information from an administrator and/or franchisor can be installed in the system media in various ways, depending on the application. For example, in one embodiment (not shown in FIG. 1), at least some information can be received with a dedicated communications channel controller that is operable to store information directly in media such as 112 without intermediation by a system processor 108. Various embodiments can have storage media based on different technologies. For example, machine readable media 112 can include volatile media such as a high speed cache, conventional CMOS memory (DRAM), and/or involatile media such as a compact disk (CD, DVD, CD-R. CD-RW, DVD+/−R, RW), semiconductor flash memory, magnetic memory such as core memory, MRAM, magnetic film, and/or others. Content from a franchisor in an optical disk or other relatively inexpensive “read only media” can be copied into different system storage media for use, and/or can be directly accessible online by way of a reader coupled to the system (i.e. a flash card can be mounted and read using a flash media reader, a CD-R disk can be read in a CD/DVD reader, etc.).

Various system embodiments with respect to FIG. 1 are operable for a franchisee to author a preapproved promotion. In some aspects, a franchisee can access a system by way of a franchisee user interface 110. An authoring module of the system can be effectuated using a processor 108 to perform instructions and/or operate on data stored in machine readable media 112. The instructions and/or data for the authoring module can comprise filtering rules comprising requirements operable for a franchisee to author a promotion and provide the franchisor's preapproval without any human intervention. The filtering rules can limit a layout, the content of various fields, media in which publication is preapproved, and/or various other aspects of a franchisee authored promotion, without any human intervention. However the rules and/or requirements can allow considerable variability in form and/or content of promotion media.

In various embodiments, a franchisee can input information comprising selected elements of content, and/or various attributes for promotion media by way of a franchisee user interface to an authoring module. The authoring module can use a set of filtering rules to reject some of the element selection, and/or can require the input of other elements and/or attributes during through interactions using the interface. Accordingly, the system can detect and approve content and/or structure that conforms to the franchise requirements and/or the filtering rules, and can reject and/or deny approval where there is non-conforming content and/or structure. The system can thereby effectuate franchisee authoring in a promotion media strictly meeting all of the franchisors requirement. A promotion product authored with the system can be preapproved.

In various aspects, a franchisor can change and/or update various filtering rules, filtering rule dependencies, promotion product specifications, requirements, and/or content in the system to offer its franchisees new and/or different options in a preapproved promotion product, and/or can add or remove promotion products.

A machine readable representation of the promotion media created with an authoring system with respect to FIG. 1 can be sent to a final mastering module 114. The final mastering module is to produce a final master that is suitable printing and/or publication. The final master can be configured in a manner that is suitable for selected promotion media (e.g. the medium can be a video, a frame in an internet website, a radio transmission, a poster, a billboard, and others), depending on the application. For example, promotion media can be printed matter, and the final mastering performed at module 114 can comprise making color separation plates and/or files for the printing. In various additional embodiments, there can be final mastering for film, a television broadcast, a decal, and/or other forms of media. The final mastering can be effectuated by human workers in some embodiments. In other embodiments, a final media master can be created without human intervention, based on machine readable output from an authoring module.

A system with respect to FIG. 1 can also have a publication/distribution module 116 operable to publish and/or distribute a preapproved promotion product. The publication and/or distribution can be effectuated by a third party agent of the franchisor, and/or a franchisor-approved vendor. In a number of embodiments, a franchisee can use the system to define a market for a promotion. A market definition can be based on geographic and/or demographic variables. Furthermore, the authoring can allow and/or insert content in the promotion media that is based on geographic and/or demographic characteristics in a market definition. For example, where a promotion is directed to an ethnic population such as an Italian population, the authoring module can insert and/or offer to insert an imagery or other affinity content related to the ethnicity (e.g. to Italy). The system thereby provides means for a franchisee to author a promotion specifically for a selected market, and to selectively distribute the promotion to recipients within the selected market.

In various embodiments, a third party business entity can administer and/or effectuate at least a portion of the system. For example, a service provider can own, maintain, and/or lease a system operable to effectuate an authoring module such as described herein, and/or can use the system to provide any and/or all of the various other system services to a franchisor for its franchisees. A franchisees can access the system to authoring a promotion for a fee or other consideration. Furthermore, a service provider can provide services such as media master creation, publication, delivery and/or broadcasting, and/or others to provide a preapproved promotion product. For example, with respect to an embodiment relative to FIG. 1, a service bureau can manage a system and provide its services to a franchisor. In another embodiment, a franchisor can own at least a portion of a system that is operated by a third party service provider.

A franchisor can authorize a service provider to allow predetermined franchisees to author and/or distribute selected preapproved promotion media to a market. The service provider can effectuate secure system access for a content administrator to install various rules, filters, and/or content for franchisees to author a preapproved promotion. The content administrator can be the franchisor or a delegate. Furthermore, one service provider can provide preapproved promotion system services to a number of different franchisors and their franchisees.

In an alternative embodiment, a system can be licensed to a franchisor for its exclusive use. The system can be operated and/or administered for the franchisor or its agents and/or employees. The franchisor can provide a level of system access to franchises that is sufficient to create and/or send preapproved promotions to a market with the system, while safeguarding the system against unauthorized access. Although some embodiments relative to FIG. 1 have different system administrator 104 and franchisor 105 interfaces, there are further embodiments having a common interface for a system administrator and a franchisor promotion administrator.

In some embodiments distinct user interfaces can be provided for different users, and/or to effectuate different functionality. In some embodiments, at least a portion of an user interface is provided with instructions and/or data from a central physical unit such as a computer processor and its local storage media. Also, in some embodiments, a user interface selection can depend on which physical unit is used to access the system. Furthermore, various user interfaces can comprise hardware devices provided in a physical unit that is used to access a system.

For example, in one embodiment a human interface for a franchisee is effectuated using first application instructions performed by a processor in a first remote processor station that is coupled to the system by way of a communications channel. The communications channel can be secure. The first application instructions can be stored in first media associated with the first remote processor. There can be further instructions in the first media for providing another human interface for a system administrator. A human interface for the system administrator can be effectuated using the first remote processor, or a another remote processor, depending on the application. The other remote processor can have distinct media comprising instructions operable to effectuate the system administrator interface. A remote processor station can have various input devices and/or output display devices for an interface. For example, a remote processor station can have human interface devices such a screen, a keyboard, a tracking and/or pointer device, microphone, a speaker, and/or others for a franchisee and/or administrator human interface.

In some embodiments, an internet browser in a remote personal computer can provide distinct system administrator, franchisor, and franchisee human interfaces in Open System Interconnect (OSI) application layers with respective instructions and data sent to the remote computer by way of hypertext transfer protocol (HTTP) messages in a communication channel. The HTTP messages can be sent by a system processor such as 108 with respect to FIG. 1. However the scope of the claims does not depend on any specific physical hardware or server configuration, any specific operating system, using an application OSI layer, a communications channel, and/or specific human interface instructions, data and/or devices.

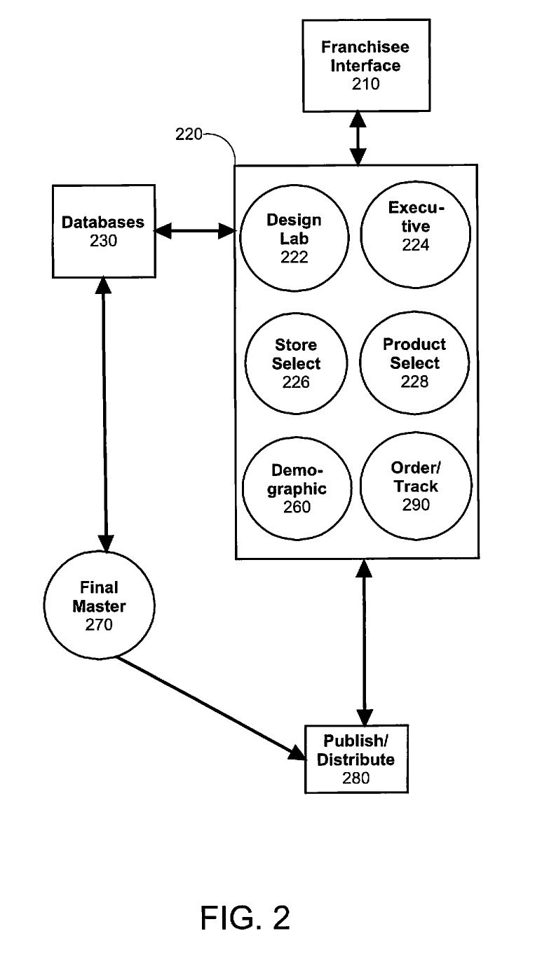

An embodiment of a franchisee interface and franchisee modules that are operable to author a preapproved promotion can be further understood with reference to FIG. 2. Authoring module 220 can include an executive module 224 for accessing various other modules, a product selection module 228 operable to select a promotion product, a store selection module 226 to select franchisee stores for a promotion product, a design lab module 222 for selecting and/or authoring content for the promotion media, and/or a demographics/distribution module 260 that can decide and/or select recipients of a promotion. The executive module 224 is operable to select and/or sequence the performance of tasks using other modules in 220, and/or can transfer information to and/or from databases 230.

Various modules in the authoring module can receive data from and store data in various databases 230. Databases can be in local and/or remote media. Remote media databases can be accessed over a communications channel. For example, there can be a database comprising various characteristic data associated with the stores of a franchisee. The characteristic data can include an identifier of a store, an address of a store, a size of a store, products that are and/or can be offered by a store, dates and/or times when the products can be and/or are offered, demographic characteristics of a neighborhood related to the situs of a store, a telephone number for the store, business hours of a store, and others. By way of example, a franchisee can be a restaurant and a database can have various menus offered at predetermined times and/or dates.

There are embodiments comprising demographic and/or geographic databases having ethnic composition and/or household income levels of various neighborhoods. The ethnic composition and/or household income level information can include data relating to a selected neighborhood. The selected neighborhood can be proximate to the situs of the store. Databases in the system can also have information relating to nearby businesses, mapping information operable to generate directions and/or maps, and others.

A database server and/or media comprising a database can situated at the same physical location as an authoring module processor (e.g. such as a processor effectuating modules 222, 224, 226, 2228, 260, 290 with respect to FIG. 2). However the server and/or media can be at a remote location, and/or can be distributed at various different locations. For example, a demographic module 260 can request demographic information from a remote third party demographic database server. The request to the remote server and/or response from the remote server can be sent over a public network (such as the internet), and/or in a secure communications channel such as a virtual private network and/or a secure sockets layer, depending on the application. There are also embodiments where a request and/or response can be sent and/or received in a secure private network. Various information obtained from local or remote databases can be proprietary data of the franchisor, proprietary data of a third party, and/or publicly available data.

In some embodiments an executive module 224 is operable to effectuate communication with a franchisee using a franchisee human interface 210. There are embodiments where the executive module 224 can mediate access to other modules in an authoring module 220 with respect to FIG. 2. For example an executive module 224 can decide to accept a franchisee request for access to the system and/or its various modules such as the modules supporting authoring functions. An executive can also perform other gatekeeper functions for secure communications and/or access to the system. In some embodiments the scope of an administrator's access, and/or a franchisee user's access can be limited by characteristic identifying information received in authentication (i.e. a location, a name, associated network information such as. an internet protocol (IP) number, MAC number, a DNS location, and/or others).

A promotion product selection module 228 is useful for a franchisee to select a promotion product and, in some embodiments, a franchisee can select from various alternative forms and/or options in a promotion product. For example, there are embodiments where preauthorized promotion media can be a flyer, a doortag, a poster, a brochure, a mail insert, a web banner, a webcast, and others. Accordingly, the franchisee can select one or more of preauthorized media for the product with the product selection module, and can use the system to author preapproved promotion content in the selected media. The preauthorized media and other aspects of a promotion product configuration and/or content can be limited by a set of filtering rules. A set of rules applying to a franchisee and/or the product selection can be selected from among the various filtering rules from the franchisor in system media, without any human intervention.

Depending on the embodiment, the set of filtering rules limiting a licensee and/or promotion product can be based on an identifying characteristic of the franchisee, the promotion product selection, a content selection, a store and/or market selection, a media selection.

For example, in one embodiment, a first franchisee that has high sales volume, and sells certain franchised memorabilia at a store in an ethnic neighborhood in city A, may be preauthorized to select promotion products, and to publish content in a doortag that would be unauthorized under a different filtering rules set for a second franchisee selecting the same promotion products, neighborhood, city, and doortag media. Furthermore, rule set selection can depend on variables such as the geographic and/or demographic characteristics of market recipients, geographical store locations, and other variables in a nonlinear manner. In a number of embodiments, a static rule set is selected for a franchisee and promotion product. However there are embodiments where the rule set can change during a franchisee's interaction with the system, depending on franchisee selections made during the promotion product configuration and/or authoring.

A store selection module 226 can be operable to select stores for a promotion. A store can be selected from among stores that are preauthorized for a selected type, form, and/or other defining characteristics of a promotion product. In some aspects, the store selection module can select one or more attributes from among various attributes of a store to include in a promotion. For example, attributes such as a photo of a store, an address of a store, a map of a neighborhood of the store, and others can be selected, depending on the embodiment. However there are embodiments where attributes of a store for inclusion can be selected solely in the design lab module 222, or can be selected from more than one module (e.g. in a design lab module, a store selection module, and/or others).

The demographics module 260 is for selecting potential and/or actual recipients for a promotion, and/or for finding demographic information concerning potential and/or actual recipients. The selection of recipients can be based on demographic characteristics of the recipients such as income, geographic location, and others. There can also be a module 290 for ordering and/or tracking the creation and/or distribution of a promotion, a module 270 for final mastering of an authored promotion, and a module 280 for publishing and/or distributing an authored promotion.

Furthermore, there can be a preapproved media layout template for authoring predetermined combinations of preapproved content in a layout. The layout template can include positions and/or areas in which authorized content can be placed by a franchisee. Furthermore, the content of a selected position and/or area and the scope of content authorized for inclusion in each respective positions and/or area of a layout can be limited by the franchisor. For example, one position in a layout of a promotion can be populated with preauthorized content operable to be selected by a franchisee. The content can be limited to text, an image, a logo, and/or a predetermined combination of text, logo and/or other forms of communicational content. The preauthorized content can be limited by predetermined characteristics, such as characteristic color(s), a characteristic orientation and/or position relative to other content, and/or preauthorized font characteristics (e.g. font family, font styles, font colors, letter positions, kerning, etc.), among others.

In a number of embodiments with respect to FIG. 1, various modules can be effectuated with instructions and data stored in media 112 and a processor 108 operable to perform the instructions and operate on the data. However there also are embodiments having at least some functionality effectuated by humans. For example, there are embodiments where human employees can produce master media 114 with various tools such as computer based workstations. In various embodiments, media masters can be made by a franchisor's authorized service center, a third party vendor, and/or others in single and/or combination. Data comprising an authored promotion (e.g. the promotion output from an authoring module) can be sent to a master media creator in physical storage media, in a communications channel (for example in a transport protocol layer such as TCP/IP over a network) and/or others.

In various embodiments an authoring module 220 further comprises a store selection module 226 and/or a demographic module 260 as shown with respect to the simplified diagram in FIG. 2. However the various modules shown in FIG. 2 are not limiting and further embodiments can have various other and/or additional modules and/or information flows, depending on the application. As merely one example, in some embodiments, a product selection module 228 with respect to FIG. 2 can be a component within a design lab module.

In a number of embodiments, a store selection module 226 with respect to FIG. 2 can be used by a franchisee to select one or more preauthorized stores and/or store locations associated with a franchise to include in a promotion. A store selection module 226 can be a component of an authoring module 220. In various embodiments, a franchisee user interface, such as 110 with respect to FIG. 1 and/or 210 shown with respect to FIG. 2, is operable to provide access to the store selection module 226. Information concerning store and/or store location authorization can be in a database having stores and/or locations of a franchisee that are authorized to be included in a promotion. A database comprising franchisee stores and/or various parameters defining the scope of authorization and/or eligibility can be maintained by the franchisor and/or an authorized database administrator. A system and/or franchisor administrator can be a database administrator. Furthermore, authorization for a location and/or store can be limited by various rules to define the scope of a preauthorized promotion. For example, there can be a rule limiting stores in a promotion to franchisee stores in a determined geographical area, and/or a combination of geographical areas, there can be a rule limiting the number of stores of stores in a promotion, and/or others. It can be seen that various rules in a database limit store selection, depending on the application.

In various embodiments, an authoring module can provide content based on selections made by a franchisee. For example, an embodiment can offer promotion content depending on characteristic information concerning one or more selected stores. The characteristic information can include a store location, contact information (i.e. telephone numbers, email address, etc.), images related to the neighborhood associated with a store, a menu of items offered for sale at a store, and/or others. The characteristic information can be in a system database, can be input by a franchisee, and/or can be acquired by other means, depending on the application.

The system can have an ordering module 290 operable to order production and/or publication of a promotion and/or select destinations for delivering the promotion. The ordering module can allow the franchisee to select a publisher and/or distributor from among providers that are preapproved by the franchisor. The ordering module 290 can also be operable for a franchisee to effectuate electronic payment for the order. The electronic payment can be performed with conventional means known to those having skill in the art.

The ordering module can obtain various authorized destinations from a database. Delivery destination information can be entered into and/or updated in the database by the franchisor, and/or a third party agent of the franchisor. In some embodiments delivery destination information for a promotion can be provided to the system by various other parties such as a franchisee and/or its representative.

Furthermore, the ordering module 290 can be coupled to a demographic module 260 for selecting recipients. The demographic module can obtain a list of prospective promotion recipients from demographic and/or geographic databases. In one embodiment, a set of prospective promotion recipients is selectively defined with demographic parameters relating to information in a database. For example, the demographic attributes of prospective recipients in a database can include age, sex, race, religion, personal income, residential address, residential property value, food preferences, number of children, and/or various further characteristics. A franchisee can thereby identify recipients to consider based on their having a set of characteristics within selected ranges of chosen attributes For example, there are embodiments in which a franchisee can author a promotion for sending to recipients within a selected age group, residing within a selected distance of a franchise location, having a selected sex, and/or having other characteristics within a selected subspace of demographic and/or geographic parameters. For example, in one embodiment a restaurant franchisee can select the recipients for a promotion to be males, in the age range of 8-18 years, and residing within 5 miles of one and/or more of the franchisee's restaurant locations. It can be seen that the system can send a preapproved promotion to demographically selected recipients.

In various embodiments, a franchisee can obtain demographic information relating to a list of prospective promotion recipients. For example, there are embodiments where a list of at least some prospective recipients for a promotion can be input into the system by a franchisee. In other aspects, at least a portion of the list is obtained from a database accessible to the system. A franchisee can enter a query into the system to obtain demographic data relating to prospective recipients in the list. The query is processed using demographic module 260. Furthermore, a subset of the list can be selected based on results of a query.

For example, in some embodiments a franchisee can obtain prospective recipients having a selected gender, a selected marital status, and/or other attributes in a list. In a number of embodiments, the system is useful to further characterize the population in a list. For example, a franchisee can query the system to determine an income statistic of the list (such as a mean income, a median income, or the modal income) and/or display numbers of prospective recipients in the list as a function of income level. The income and/or list can be of individuals, of households, and/or other units. The statistics and/or distributions can communicated in a chart, graph, or other form in a user interface. Although income has been used by way of example, the system can characterize prospects in terms of other parameters such as age, weight, etc. A franchisee can thereby create lists of prospective recipients for a promotion and the franchisee can examine the numbers and/or demographic characteristics of the prospective recipients in various lists. Based on such information, a franchisee can select one or more lists to receive a promotion.

A preapproved authored promotion, and/or a list of selected recipients for a promotion, can be stored in a database 230 using the authoring module 220. A franchisee can access an order/tracking module 290 by way of the franchisee interface 210 to effectuate publishing the promotion in media that is selected using a product selection module 228. The publication can be sent to various selected recipients. The recipients can be selected based on demographics, location, and/or in other ways, at least including those disclosed herein. The preapproved authored promotion in the database can be accessed by a final mastering module 270. The final mastering module 270 can prepare a publication master from the authored promotion and can send the publication master to a publishing/distribution module 280 to effectuate publication in tangible media, and/or in other media effective for distribution to recipients.

A franchisee can direct publication to occur at one or more predetermined times, or at predetermined times that can depend on certain events and/or the absence of certain events. For example, there are embodiments where a franchisee can enter an order for a publication subscription, wherein a promotion is published to selected recipients on a recurring basis, and/or the system automatically posts charges to a franchisee responsive to effectuating each instance of the publication. In a number of embodiments a franchisee can effectuate a subscription comprising recurring charges to a franchisee's credit account that are entered on a weekly, monthly, or other periodic basis, using an ordering module 290. The charges can be entered prior to, subsequent to, or concurrently with each instance of the publication. Each instance and/or recurrence of the promotion publication can be to one or more predetermined sets of recipients.

In some embodiments, a preapproved promotion postcard can be authored by a franchisee with the authoring module 220. The franchisee can select stores to feature in the promotion with the store selection module 226. Furthermore, the franchisee can select recipients for the promotion with demographic module 260. The authored promotion and/or a list of selected recipients for the promotion can be stored in a database. In one embodiment, the franchisee can enter an order for sending the promotion postcards using order/tracking module 260. The order/tracking module can actuate and/or communicate information to a publishing/distributing module 280 effective for the postcards to be printed and/or sent to the selected recipients. In the embodiment, the publishing/distributing module can enter a request to final mastering module 270 for a final master of the promotion. Final mastering module 270 can obtain a file comprising the authored promotion from a database 230 and can create a publication master from the authored promotion file that is useful for module 280 to effectuate a printing of the promotion postcards. In a number of embodiments, order/tracking module 290 can obtain the list of selected recipients from the database and can transmit the list to the publishing/distributing module for the sending. However in some embodiments a publishing/distributing module can query a system database to obtain a list of recipients for the order.

In another embodiment, a franchisee can author a preapproved promotion for postcards with the system and/or can order a number of the postcards to be delivered to a franchisee location. There are also embodiments where at least some postcards can be delivered to a franchisee, and the delivered postcards can be distributed without using the system. For example, a franchisee can order promotion postcards and the franchisee can take them to an independent provider for sending. The provider can send postcards to recipients in a franchisee's list, and/or to recipients in another list. In further embodiments, a preapproved poster and/or handbill can be authored, and copies of a printed poster and/or handbill are delivered to various franchisee locations. The posters can be displayed at franchisee locations and/or in other locations. In yet another embodiment a promotion is published in video media. A publishing module 280, and/or a franchisee, can communicate the video to prospective customers and/or influencers in various ways. For example, a publishing/distributing module 280 can effectuate publishing a video by way of a user accessible internet site. Furthermore, a module such as 280 can email the video to selected recipients. The module 280 can also and/or alternatively send the video for display in a theater, for display at a franchisee location, for display on an end user DVD player and/or multimedia appliance, and/or at for display at various other places and/or in other ways.

The ordering module 290 can also include order tracking functionality for tracking the status of an order that has been placed. For example, a franchisee, an administrator, and/or a franchisor can enter a query by way of the ordering/tracking module 290 (also referenced herein as “order/track” module). The query can be to determine whether a media master has been completed, whether a media master has been sent to the publishing/distribution module (also referenced herein as “publish/distribute” module), whether a promotion has been distributed to recipients, whether various services and/or goods in an order have been delivered, and/or various other status information relating to an order. Furthermore, in various embodiments the order/track module can be used by a franchisee to enter an order to publish a previously authored promotion, and/or for sending and/or resending a previously authored promotion to the same and/or other selected recipients. Information regarding media mastering production and/or delivery status relating to an order can be sent from the final master module 270 into a database 230. Also, information regarding the status of publishing and/or distribution of an order can be stored in a database 230 from the publish/distribute module 280 by way of another module such as an order/track module 290.

Although a single module 290 can be used to effectuate ordering, tracking, and or obtaining status of the publishing and/or distribution of a promotion as shown with respect to FIG. 2, there are embodiments where ordering, tracking, and/or interrogating various status records of an order can be performed with a plurality of modules. For example, ordering a promotion can be performed with a separate ordering module, order tracking can be performed with an order tracking module, and publishing and/or distribution status can be interrogated with a status module. Various modules can be accessed in single and/or in combination by way of combined and/or separate user interfaces, depending on the application. Furthermore, a status of various orders, requests, promotion distributions, and/or other events and/or milestones can be interrogated by a user, and/or communicated to a user in a number of alternative ways.

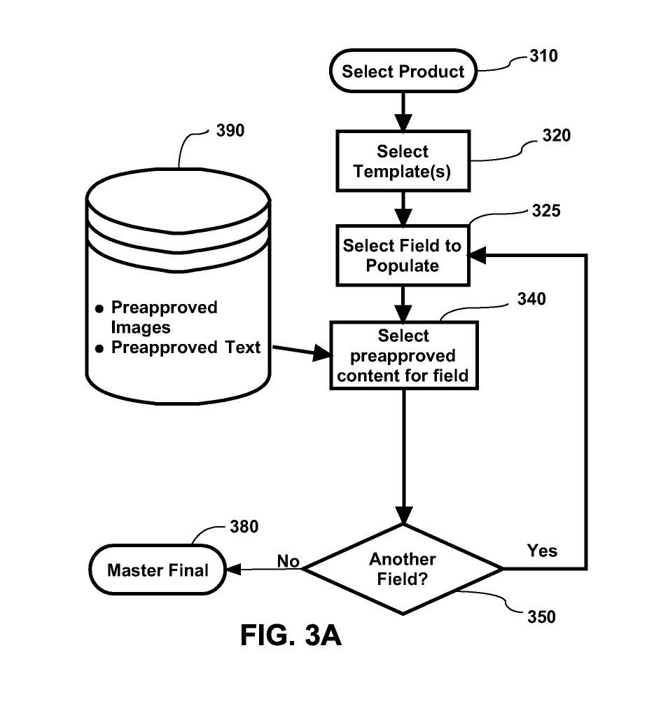

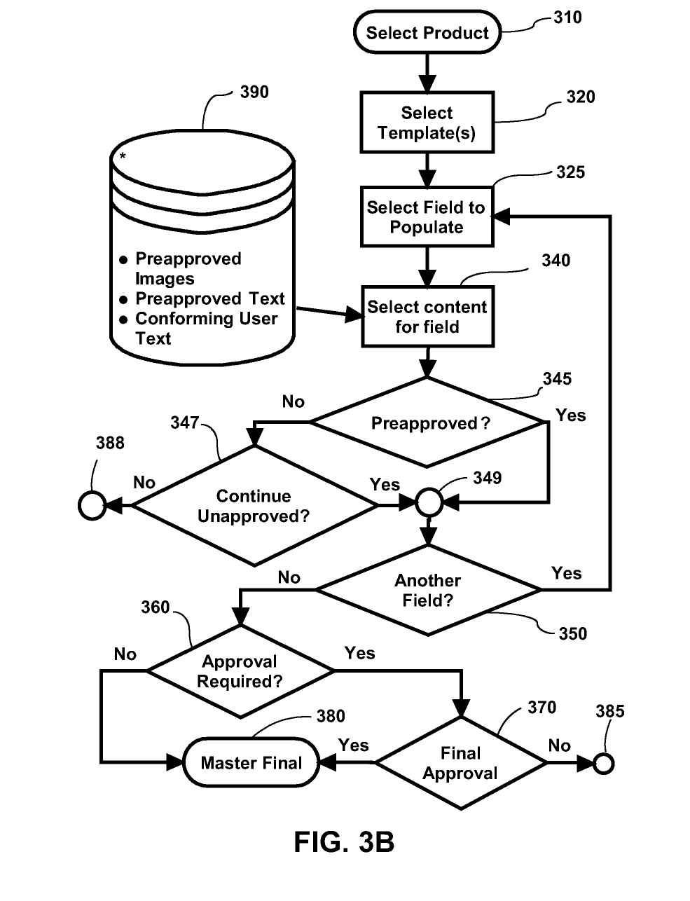

An embodiment of an authoring system having a design lab can be understood with respect to FIG. 3A. In this embodiment, a design lab comprises steps 310-350. At 310 a franchisee can select a product for a promotion. The product can include media such as a postcard, a poster, a video, and/or others. In various embodiments the product can also include preapproved distribution to a market. At 320, a franchisee can select an authoring template for the product. At 325 the franchisee can select a first field of the template to populate with content. The template can have a plurality of fields. At 340, a franchisee can select preapproved content for a first field from among alternative content in a database 390. The content can be mandatory and/or optional and can comprise text, a graphic, video, audio, and/or others. For example, there can be rules for a restaurant promotion allowing a franchisee to insert optional descriptive explanation relating to caloric content of a food item.

The embodiment can include rules to allow and/or restrict application of various preapproved attributes to at least a portion of mandatory and/or optional content. For example, there can be a rule allowing a franchisee to select bold characters, italicized characters, and/or apply other types of highlighting to at predetermined portions of content in a field. In a further embodiment, preapproved text characteristics such as a font, a font style, a color, an orientation, a size, and/or other characteristics can be applied to at least some mandatory text. The text, characteristics, and or rules operable to permit and/or restrict text characteristics can be in a database 390.

Preapproved mandatory and/or optional content in a field can be selected from alternative content in a database and/or can be limited by predetermined rules, depending on the application. Furthermore, there can be restriction rules controlling content. For example, a logo can be limited to an authorized font. A characteristic image or trade dress can be limited to authorized colors. A geometrical position, orientation, and/or relationships between objects can be limited by predetermined rules concerning configurations. There can also be rules operable to propagate preselected content from one field into another field, and/or limit some content in at least one field to have a predetermined relationship with respect to the content of another field in a promotion.

Mandatory content can be user-selectable from among predetermined alternatives. For example, a rule can allow a franchisee to select a logo and/or trademark in a field from among alternative logos and/or marks of the franchisor. A rule can further require a franchisee to select at least one style attribute from among mandatory styles relating to the franchisor's trade dress, logos, and/or marks. In some embodiments, selection can be performed in a user interface menu coupled to a design lab module such as module 222 in an embodiment with respect to FIG. 2.

After content in for a field has been entered at 340, at 350 a system can proceed to decide at 325 to select a field for adding and/or updating content at 340. At 340, preapproved content can be added to the selected field and/or edited in a preapproved manner. In some embodiments a system has rules operable to effectuate the placement of mandatory content in various predetermined fields by way of performing steps (325-340). There can be a predetermined sequence of fields to populate with content, or a sequence of fields to populate can be determined by the system based on rules and/or user interaction, depending on the embodiment. For example, there are embodiments where, at 350, a system can select a field wherein content is added and/or updated (at 325) with no user interaction. In various embodiments the system can add mandatory content comprising predetermined text, a graphic, a logo, a trademark, and/or others.

FIGS. 2 and 3A depict embodiments where designated modules perform various steps in a system. However various modules of a system can be organized in other ways. For example, in one embodiment with respect to FIG. 2, product selection is performed in module 228 and design lab module 222 performs no product selection. However in a different embodiment, the design lab module comprises product selection. Accordingly, the modules that are operable to effectuate a system can be organized in various different ways that are within the scope and spirit of the disclosure. The scope of the claims is not limited by any hierarchy or architecture connecting modules, or by having any step performed in a particular module.

In various embodiments, a franchisor can offer specific preapproved content for a predetermined market. The predetermined market can relate to geography, demographic attributes of potential customers and/or influencers, and/or others. For example, there can be preapproved content comprising text messages and/or multimedia appealing to teenagers. Furthermore, there can be content designed to expand sales of a franchisee in existing markets and/or into additional markets. The content for expanding sales can be related to geography, regional demographics, and/or other characteristic that can appeal to customers and/or influencers in a target market segment.

In further embodiments a franchisor can offer cooperative promotions to selected franchisees. A cooperative promotion can reduce cost for a promotion since relatively fixed costs for creating a media master, and for purchasing advertisement space and/or time in newspaper, television, radio, and/or others, can be shared among the franchisees accepting the program, the franchisor, a product manufacturer, and/or others. For example, a pizza franchisor can offer a cooperative program to selected franchisees located in Detroit. The selection can be based on sales volume, demographic characteristic of franchise neighborhood, and/or others. The cooperative program can be presented to a franchisee in a user interface of system. The user interface can be in a web browser window that is displayed upon logging in to the system using HTTP in a secure sockets layer (HTTPS). However there are embodiments where a user interface can be effectuated by way of other secure means such as a virtual private network, a private network, a terminal that is physically attached to the system, and/or others. In still further embodiments at least some franchisee interaction with the system is insecure.

Although restricting the scope of content in a preauthorized promotion can be effectuated using menu selection as has been disclosed, embodiments can restrict content in other ways. In some embodiments, a franchisee can input its own text and/or other content for a field of a template. The franchisee's input can be analyzed using predetermined restriction rules (also known as filters) in a system. A content filter can be effectuated using various methods. For example, content filtering can be based on linguistic analysis, artificial intelligence, searching a database to identify impermissible words and/or phrases in single or in combination, and/or other methods, depending on the application. Where a promotion consists of various preapproved content from a system database and/or user content conforming to various restriction rules, it can be preapproved by the system. Furthermore, selection of a filtering rule set selected for one franchisee authoring a cooperative promotion can depend on the preapproved authoring already performed by other franchisee subscribers.

Restriction rules can be effectuated with a filtering module that is operable to determine an approval status of user content. The module can preauthorize content based on various rules, and can accept and/or reject content based on rules. In some embodiments, a filtering module can apply rules to decide that the content must be further evaluated to decide an approval status. In various embodiments, a filtering module can process content comprising text, audio, images, and/or other forms of content. The text can processed based on phonemes, words, phrases, and/or sentences. Filtering can be based on a one and/or a combination of content characteristics. For example, there can be a filter operable to deny preapproval for content having a competitors name, logo, and/or trademark. Furthermore, a filter can be configured to deny preapproval for content comprising offensive words, phrases, and/or images, and/or further criteria.

In various embodiments, there can be a module operable to modify problematic content in a manner that can effectuate preapproval. The system can allow a franchisee to access the module in a user interface. The module can highlight one or more suspect portions of the content in a display to the franchisee, and/or can display various rules, criteria, and/or explanation concerning aspects of the suspect content that can be operable to deny preapproval. In number of embodiments, the system has a content editor operable for a franchisee to alter and/or remove problematic content. For example, there are embodiments where a franchisee can view and/or alter problematic text in a text editor and alter the text in a manner to effectuate preapproval. In some further embodiments, there is a rule-based correction module that can substitute and/or modify at least some disallowed content without human interaction. The modified and/or altered content can be preapproved. There are also embodiments where the franchisee interacts with a correction module through a human interface. The correction module can offer alternative substitutions and/or modifications for the franchisee to make a selection. Furthermore, in some embodiments allowable content can be changed by a franchisee. In various embodiments the correction module is operable to change and/or preapprove at least a portion of the content in a promotion.

Various embodiments can be useful to author a promotion comprising a preapproved first portion and a second portion that is ineligible for preapproval (known as a dual system). In one of these embodiments, various rules can detect a portion having ineligible content, and can send at least that portion to the franchisor for review. For example, in a dual system embodiment relative to FIG. 3B, a module can detect ineligible content at 345, and can decide to send (at 360) at least the ineligible portion to a franchisor for “post-authoring” review (at 370). In one aspect, a franchisor can consider and approve the ineligible portion at 370, and the promotion can be sent for final mastering at 370, based on the franchisor approval. In another aspect, a franchisor can review an ineligible promotion as a whole, and/or grant approval. It will be understood that in the alternative a franchisor can deny approval (385).

There are dual system embodiments in where at least some suspect content is strictly rejected and disqualified for post-authoring review. For example, a franchisor's rules can strictly reject any content comprising a competitor's trademark. A dual system can have rules operable to deny post-authoring review based on various information, attributes, and/or characteristics of the content in an authored promotion.

An exemplary dual system embodiment for processing a promotion having preapproved, post-approvable, and/or ineligible content portions can be further understood by reference to FIG. 3B. Like numerals of FIGS. 3A and 3B refer to like function. Steps 310, 320, 325, 340, 345 and media 390 shown in FIGS. 3A and 3B perform like functions. With respect to FIG. 3B, after content is selected for a field at 340, the system can decide preapproval of that field based on various rules. Where the content is preapproved, the system can proceed to step 350 and then to 325 for adding and/or updating content in a selected field, or to 380 to decide if there will be post-authoring review.

Rules limiting the content in a field can deny approval at 345. Where there is no preapproval (“no” at 345), a franchisee can decide to continue authoring (“yes” at 347) by way of 349 and 350. At 350, it can be decided to add and/or modify content in a further field (“yes”), or complete authoring (“no” at 350). At 360 a system can decide whether the authored promotion is preapproved (“no” at 360) and can send a preapproved promotion to perform final mastering 380 for publication. Where a promotion has an unapproved portion that is post-approvable (“yes” branch at 360), the system can send at least an unapproved promotion to the franchisor for review (at 370). The franchisor can decide approval (“yes” at 370) and/or deny approval (385). A post-approved promotion can be sent to a final mastering module (380).

In further embodiments, a franchisee can input at least some content when authoring a promotion. The content can evoke a restriction rule effective to deny preapproval (e.g. the franchisee user's content is rejected in a filtering module). Responsive to performing rejection, the system can load problematic content causing the rejection into a module that can display the problematic content and/or perform substitution. In various embodiments, the system can highlight various suspect portions and/or attributes of the problematic content in a user interface. Furthermore, the system can provide substitute content operable to cure the rejection and effectuate preapproval. In some embodiments, a system can provide alternative substitute content to a franchisee in a user interface. The franchisee can select one of the alternatives and thereby effectuate preapproval. In some embodiments a system can replace at least some problematic content without human interaction.

Status information concerning various aspects of the authoring and/or publishing can be entered into a database of the system. Various modules can interrogate the database to receive status information. For example, in a number of embodiments with respect to FIG. 3B, status concerning preapproval, approval, and/or rejection can be entered in a database at 345 and/or 370, and the approval and/or preapproval status information can be interrogated at least at 360 and 370, and/or with various other modules and through human interfaces.

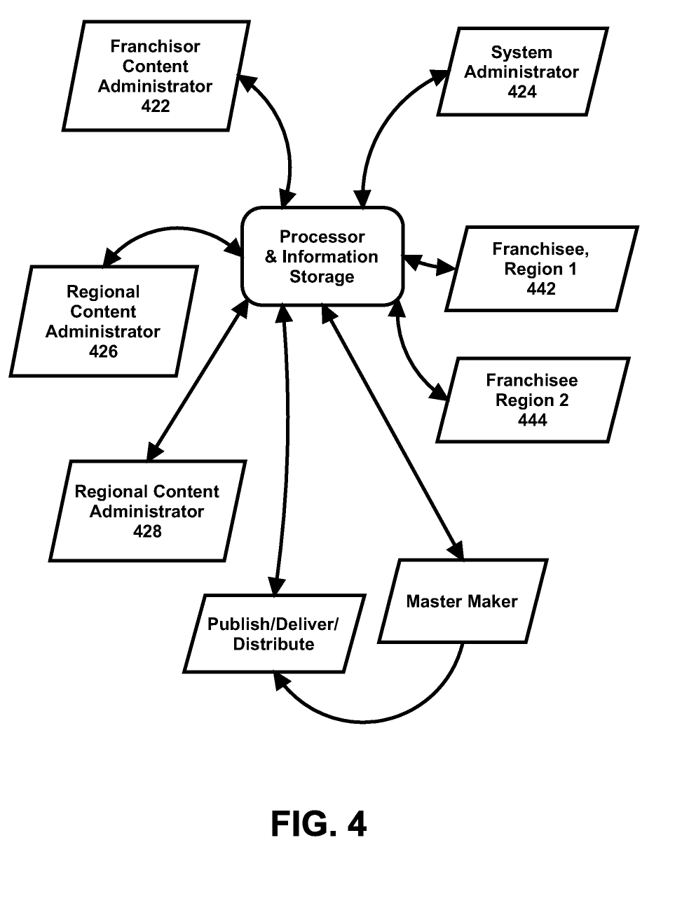

Further embodiments are operable to author a preapproved promotion where the preapproval can depend on demographic and/or geographic variables relating to a franchisee, and/or content that is preauthorized for the franchisee. A number of these embodiments can be understood with respect to FIG. 4. There can be a system administrator 424 having authority to access and/or modify predetermined information in the system. In some embodiments, a system administrator is authorized to install and/or update any instructions and/or data in a system. However there are other embodiments where a system administrators access can be limited, depending on the application. For example, there are embodiments where a franchisor has exclusive access to some information that is inaccessible to the system administrator (For example, in some embodiments a franchisor's rules, database, and/or content can be inaccessible to the system administrator).

A franchise can have one or more franchise content administrators such as 422 with respect to FIG. 4. Furthermore, a system for authoring and/or publishing preapproved promotions can be operated and/or owned by a service provider. A franchise content administrator 422 can administer any portion of a franchisors information, such as a franchisor's database, a franchisor's preauthorization rules, franchisor content, and/or others. In various embodiments, a system can provide preapproved promotion authoring and/or publishing services for a plurality of franchisors and respective franchisees. Different franchisors and their respective franchisees can be concurrently supported with one system. In embodiments where a plurality of franchisors use one system, each franchise can have its own content administrators, and the content administrators for a franchisor can have exclusive access to information relating to the franchise. On the other hand, there are embodiments where multiple franchisors engage the same content administrator (e.g. the same content administrator can be authorized to access content for a plurality of franchisors).

A franchisor can manage promotions in various ways. There can be a franchisor content administrator 422 having overall authority and/or administrative access to define limitations, content, scope, and/or other characteristics of any preapproved promotion for the franchise. On the other hand, a content administrator's access to various aspects and/or resources can be limited.

In a number of embodiments there is a master system administrator 424. A system administrator 424 can have unlimited access to update and/or configure any information (instructions, rules, content, etc.) in the system. However, there are embodiments where the system administrator's access to information in a system can be limited. For example, a portion of a franchisor's information, such as rules and/or content for preauthorized promotions, can be stored in an encrypted form that can be accessed solely by a franchise content administrator. The scope and control of access to the system and data by various administrators, franchisees, and others can be limited using conventional means known in the art. For example, selective administrative access can be effectuated using password, secure key, biometric, smart card, and/or various other means for authentication and/or encryption.

Information that can be accessed and/or modified by a content administrator is generally limited. At least a portion of a franchisor's information can be in an unmodifiable form and/or in a form that cannot be deleted. For example, information can be in a read-only media such as a read only optical disk or holographic memory. In further embodiments, some system and/or other administrators access can be limited to updating predetermined data and/or instructions. For example, in embodiments where a plurality of franchisors and their franchisees obtain system services from a third party service provider, a franchisor content administrator can have administrative access and modification privileges that are exclusively limited to accessing, installing and/or updating rules and/or content relating to the franchisor's franchisees and/or promotions.

A franchisor can exclusively offer a preapproved cooperative promotion exclusively to certain franchisees. For example, an offer can be exclusive to franchisees and/or franchisee stores in a predetermined region, exceeding a certain sales volume, having selected demographic characteristics, and/or based on further characteristic attributes. Furthermore, the scope of acceptable content in a preapproved promotion and/or a preapproved cooperative promotion offer can depend on characteristic attributes such as the franchisee's location and/or other characteristic of the franchisee or franchisee's store.

In one embodiment, a regional restaurant franchisee can author a promotion having content that is only preapproved for restaurants in its region. For example, a franchisee in a first region can author a promotion having a first regional menu having food discounts for that region. The menu and/or discounts can be selected from among preapproved content in a database. However the first regional menu in the database can be inaccessible to a franchisee located in a second region. Furthermore, different filtering rules for the second region can disallow the first regional menu in any preapproved promotion for that region. In other embodiments, various further geographic and/or demographic restriction rules can limit the recipients and/or content of a preapproved promotion and/or preapproved cooperative promotion offer.

A management structure can be based on regions. In an embodiment with respect to FIG. 4, there are regional content administrators 426, 428 for first and second regions in a franchise. A regional content administrator can effectuate rules and content for preapproved promotions in the administrators region. Franchisees 442 and 444, in first and second regions respectively, can be limited by different rules and content entered by the respective first and second region content administrators. Furthermore, there can upper level content franchise administrators, such as content administrator 422, having access and authority to promulgate rules and/or content for promotions in a plurality of franchise regions.

For example, a franchisor's automobile dealerships in a first country can be administered by a first national manager who can also be a regional content administrator 426 for the first country. A second national manager can administer automobile dealerships in a second country and be a regional content administrator 428 for the second country. Also, a third regional manager (not shown in FIG. 4) can administer automobile dealerships in a third country and be a regional content administrator for the third country. During one three month period, dealerships (franchisees) 442 in the first country can only author and/or publish a preapproved promotion for trucks, and during the last two months of this period, dealerships 444 in the second country can only author and/or publish a preapproved promotion for a premium passenger car. A module for authoring these preapproved promotions has rules that depend on a franchisee's country. In further embodiments, a franchisor can preapprove a promotion and/or offer a cooperative promotion based on various other rules. The system can effectuate such rules to thereby limit the content and/or form of the promotion and/or eligibility to participate in the cooperative promotion.

In the foregoing specification, various aspects have been described with reference to specific embodiments. However those skilled in the art will recognize further aspects including alternatives, modifications, permutations and equivalents of the embodiments described herein, from consideration of the specification, study of the drawings, and practice of the disclosure. Various features and aspects-described above may be used individually or jointly. Furthermore, various aspects can be utilized in any number of environments and applications beyond those described herein without departing from the broader spirit and scope of the description. The written description and accompanying drawings are, accordingly, to be regarded as illustrative rather than restrictive.

What is claimed is:

1. A method for providing licensor preapproval for a promotion of a licensed product and/or service using a computer system, the method comprising:
receiving from a licensor filtering rules, at least one promotion media layout template for media in a promotion, mandatory and/or alternative content for media in a promotion, and at least one promotion product specification;
wherein the promotion product specification identifies promotion media for a preapproved promotion product, and the filtering rules and media layout template are operable to limit a layout, content, and/or attribute in the promotion media of the preapproved promotion product;
storing the promotion product specification, filtering rules, promotion media layout template, and/or alternative content in tangible system media;
receiving information in the system from a licensee with a licensee user interface, the licensee information comprising an identifying characteristic of the licensee; a promotion product selection for a promotion, a content selection, an attribute selection, and a store and/or market selection;
selecting a set of filtering rules from among the stored filtering rules in the tangible system media without human intervention, the set selection being based on at least one parameter selected from among the group consisting of an indentifying characteristic of the licensee, the promotion product selection, the content selection, and the store and/or market selection, wherein the filtering rule set is operable to filter at least a portion of the information from the licensee;
filtering at least the portion of licensee information using the selected filtering rule set without human intervention;
preapproving the promotion without human intervention, based on the filtering;
storing a representation of the preapproved promotion in the tangible system media; and
sending a machine readable representation of the preapproved promotion media to a preapproved producer of a media master.

2. The method of claim 1 further comprising accepting an order and an electronic payment for the preapproved promotion product from the licensee, reporting a current status of the order to a licensee, and publishing the promotion, and wherein the accepting, the reporting, and the publishing are performed without licensor interaction.

3. The method of claim 1 further comprising:
receiving from the licensor alternative trade dress and/or trademark content and storing the licensor alternative trade dress and/or trademark content in the tangible system media; and
receiving from the licensee information comprising content, an instruction to place the licensee content in a first position of the authoring template, a selection from among the licensor trade dress and/or trademark content, and an instruction to place the trade dress and/or trademark content in a second position of the authoring template;
wherein the preapproval depends on the trade dress and/or trademark selection in the second position and/or the licensee content in the first position.

4. The method of claim 1 wherein the system comprises a database having demographic and/or geographic recipient information relating to the licensed product and/or service, and the market selection comprises designating recipients for the promotion product based on querying the database.

5. The method of claim 1 wherein the system comprises a database having demographic and/or geographic characteristics associated with the store selection and/or market selection, and wherein at least some affinity content relating to the geographic and/or demographic characteristics in the database is included in the promotion media.

6. The method of claim 5 wherein the system is operable to produce a map showing the selected store location and a geographical area relating to the market selection, wherein the method comprises producing the map and including the map in the promotion media.

7. A preapproved promotion provided using the method of claim 1.

8. The preapproved promotion of claim 7 wherein the tangible system media comprises data and instructions operable to implement the method, and the method is performed using at least one processor to perform the instructions and operate on the data.

9. The preapproved promotion of claim 8 wherein the method further comprises accepting an order and electronic payment for the preapproved promotion product from the licensee and reporting a current status of the order to the licensee; wherein the accepting and the reporting are effectuated in a user interface of the system with no licensor interaction.

10. The preapproved promotion of claim 8 wherein the method is performed using a database having demographic and/or geographic information relating to the selected store and/or market, and the information from the licensee comprises designating recipients for the promotion product based on the demographic and/or geographic information in the database.

11. A system comprising data and instructions operable to perform the method of claim 1 in the tangible system media, and at least one processor operable to perform the instructions and operate on the data.

12. An article of manufacture comprising machine readable data and instructions in tangible media operable for a processor to perform the method of claim 1.

13. A promotion product produced using the method of claim 1.

14. A system for a licensee to effectuate a preapproved promotion of a licensed product and/or service with no licensor intervention, the system comprising:
machine readable media operable to store information comprising data and instructions, and
a processor operable to perform the instructions and operate on the data;
wherein the stored instructions and data are operable to implement:
a module operable for a licensee to select a preapproved promotion product for a preapproved promotion with no licensor interaction,
a module operable for the licensee to author preapproved media content for the preapproved promotion product with no licensor interaction;
a module operable for the licensee to order the preapproved promotion product;
a module operable for the licensee to make an electronic payment for the preapproved promotion product order;
a module operable for the licensee to track the status of the preapproved promotion product order; and
a module operable to send a representation of the preapproved promotion product content and media to a preapproved producer of a media master.

15. The system of claim 14 further comprising a system database including preapproved promotion products, alternative media layout forms for the preapproved promotion products, and alternative content for the preapproved promotion products, the alternative content including alternative trade dress and/or alternative media selections;
wherein the system is operable for the licensee to select the preapproved promotion product from among the preapproved promotion products in the database, and is operable for the licensee to author the selected preapproved promotion product using media layout forms and content selected from among the alternative media layout forms and the alternative content in the database; and the authoring module includes a design laboratory module operable for the licensee to select at least a form, content, a trade dress, and/or a media option in a user interface to the system.

16. The system of claim 15 further comprising an administrative user interface, the administrative user interface being operable for an administrator to install content and/or rules in the machine readable media, to allow and/or disallow the licensee to access the system, to allow and/or disallow the licensee to select a predetermined promotion product from the system database, and to define a scope of content and/or scope of distribution for the preapproved promotion product.

17. The system of claim 16 wherein the scope of content and/or scope of distribution defined for the preapproved promotion product depends on the licensee.

18. The system of claim 14 further comprising a module operable for the licensee to select a market based on demographic and/or geographic variables, and a module operable to distribute the preapproved promotion in the selected market.

19. A system for a licensee to author and publish a preapproved promotion product with no licensor intervention, the system comprising:
means for the licensee to select the promotion product;
means for the licensee to select content for the promotion product;
means for the licensee to produce a media master for the promotion product;
means for the licensee to select recipients for the promotion product;
means for the licensee to effectuate publication of the promotion product;
means for a licensor to limit form, content, media, and/or recipients of the promotion product without human intervention; and
means for the licensee to pay for the preauthorized promotion product without licensor interaction;

20. The system of claim 19 further comprising means for the licensee to participate in a cooperative promotion.
